(19) United States
(12) Patent Application Publication
(10) Pub. No.: US 2008/0230965 A1
(43) Pub. Date: Sep. 25, 2008

(54) Handling Device For Elements of Tapping Runners

(75) Inventors: Robert Gorza, Bofferdange (LU); Hans-Otto Kreuz, Wilnsdorf (DE); Ralf Taugerbeck, Netphen (DE)

Correspondence Address: CANTOR COLBURN, LLP, 20 Church Street, 22nd Floor, Hartford, CT, 06103, US

(73) Assignee: TMT - TAPPING MEASURING TECHNOLOGY SARL, LUXEMBOURG (LU)

(21) Appl. No.: 12/064,188

(22) PCT Filed: Aug. 16, 2006
(86) PCT No.: PCT/EP2006/065377

§ 371 Date: Feb. 19, 2008

(30) Foreign Application Priority Data
Aug. 19, 2005 (LU) 91 192

(51) Int. Cl. F27D 3/14; C21B 7/00

(52) U.S. Cl. 266/160; 266/196

(57) ABSTRACT

A handling device for elements of tapping runners on a shaft furnace, in particular for runner covers, the device including a support base arranged on the cast house floor of a blast furnace, laterally of the tapping runner and a frame (14) which is supported by the support base and connected thereto by means of a bearing defining a first axis of rotation, which is essentially vertical and about which the frame can rotate relative to the support base. The device further includes a lifting arm having a first end portion and a second end portion, the first end portion being connected to the frame by means of at least a first rotational joint defining a second axis of rotation, which is essentially horizontal, about which the lifting arm can pivot in order to lower or lift its second end portion. A handling member is connected to the second end portion of the lifting arm by means of a second rotational joint defining a third axis of rotation, which lies in a plane essentially perpendicular to the second axis of rotation, about which the handling member can pivot with respect to the lifting arm. Furthermore, the handling device includes a fork-type grab connected to the handling member and arranged so as to allow picking up; transferring and putting down such elements.

### TECHNICAL FIELD OF THE INVENTION

The present invention relates to a handling device for elements of tapping runners on a shaft furnace, in particular for runner covers of blast furnace main runners.

### BRIEF DISCUSSION OF RELATED ART

In order to reduce detrimental emissions and heat radiation in the cast house of a blast furnace, it is known to cover a tapping runner (also called launder or trough) by at least one mobile cover elements. Such runner covers consist of an elongated metallic case fitted with an inward refractory protection. Their dimensions can amount to several meters in length and some meters in width. Their weight may significantly exceed 10'000 kg.

For tapping and plugging the taphole however, it is necessary to remove the upstream runner cover, i.e. the runner cover which is located immediately downstream the taphole. The upstream runner cover is normally put into a parking position and put back in front of the taphole afterwards. Such handling operations are not facilitated by the usual dimensions and weight of the runner cover. Therefore, several special purpose devices for performing this task have been designed so far.

U.S. Pat. No. 4,786,250 describes a transfer device for conveying a mobile tapping runner hood (cover) in order to make room for the positioning of the tapping and plugging appliances. The device comprises a trolley adapted to run along a set of rails, a suspension and lifting mechanism and a girder framework by which the rails are supported. The suspension and lifting mechanism for lifting or lowering the hood, is mounted to the trolley which can move along the rails in order to transfer the mobile hood.

WO 01/79565 describes a device for maneuvering the cover of a blast furnace casting launder (runner). It comprises a support structure arranged adjacent to the launder with a main bearing arm connected to the support structure by a cylindrical articulation. A secondary arm is connected to the main bearing arm and a bearing element to the secondary bearing arm, each by a cylindrical articulation respectively. With the triple and parallel cylindrical articulation of the device it is possible to move the upstream cover, e.g. in parallel to itself, into a parking position above the downstream cover.

DE 39 33 894 describes a turning and lifting device for a runner cover of a blast furnace. The device comprises a vertical column arranged adjacent to a taphole and rotatable about its longitudinal axis. A cantilever arm is fixed to the vertical column and provided on its free end with a lifting device having a contrivance for picking up a runner cover.

The aforementioned known devices have the common drawback that they are relatively limited in their flexibility for positioning and orienting a runner cover. Furthermore, they are designed for handling the cover of a single runner only. Hence, in the usual case of a blast furnace having a plurality of runners, an instance of such a device is required at each runner location.

JP 10-317026, describes a device which is basically similar to the device described in DE 39 33 894, but which is suitable for serving at two different runner locations. Accordingly, the number of required devices on a blast furnace having a plurality of runners can be reduced with the resulting savings in cost (cf. FIG. 1 and FIG. 4 of JP 10-317026). Nevertheless, the type of device according to JP 10-317026 is also limited in its capabilities of positioning and orienting the runner cover.

In the cast house, available space for auxiliary devices is often very limited. This is another reason for reducing the amount of handling devices. Since there is limited space, those parking positions that can be reached by prior art devices are often not readily available. Furthermore, prior art devices have a relatively unwieldy construction and generally require attachment to fixed constructions above the cast house floor. Finally, there are often obstacles adjacent the main runner, e.g. other appliances or fixed constructions, which need to be avoided when moving the runner cover from its working position to its parking position.

### BRIEF SUMMARY OF THE INVENTION

The invention provides a handling device for elements of tapping runners, in particular for runner covers, which is capable of handling the covers of more than one runner while having a compact construction and providing high flexibility of positioning and orienting the runner cover.

The invention proposes a handling device for elements of tapping runners on a shaft furnace, in particular for runner covers. This device comprises a support base arranged on the cast house floor of a blast furnace, laterally of the tapping runner and a frame which is supported by the support base and connected thereto by means of a bearing defining a first axis of rotation, which is essentially vertical, about which the frame can rotate relative to the support base. The device further comprises a lifting arm having a first end portion and a second end portion, the first end portion being connected to the frame by means of at least a first rotational joint defining a second axis of rotation, which is essentially horizontal, about which the lifting arm can pivot in order to lower or lift its second end portion. A handling member is connected to the second end portion of the lifting arm by means of a second rotational joint defining a third axis of rotation, which lies in a plane essentially perpendicular to the second axis of rotation, about which the handling member can pivot with respect to the lifting arm. Furthermore, the handling device according to the invention comprises a fork-type grab connected to the handling member and arranged so as to allow picking up; transferring and putting down such elements.

This device allows engagement/disengagement of a runner element, such as a runner cover without additional manual intervention. It provides for lifting, transfer from a working position to a garage position and vice-versa and lowering such elements without additional instruments and interventions. Additionally, this device provides high flexibility in positioning and transferring runner elements, in particular runner covers. Among other, this allows to use a single device for service on two different proximate runners. Furthermore, it is relatively versatile as regards its location of installation. The device can be automated in relatively easy manner since it has the structure of a special purpose robot arm. Accordingly, savings in labour and increased safety can be achieved. The device is self-supporting, floor mounted and, except for its support base, does not require any additional points of fixation in the cast house. It can have a relatively small average height, even when fully lifted, such that it can also be installed underneath relatively low service floors.

According to a first embodiment, the frame comprises a pivotable member, the pivotable member being connected to the frame by means of a third rotational joint defining a fourth axis of rotation, which is parallel to the second axis of rotation. Herein the lifting arm is connected to the pivotable member, such that the lifting arm is capable of executing a forward/backward movement with respect to the frame.

According to a second embodiment, the handling device comprises a rectilinear sliding joint connecting the fork-type grab to the handling member such that the fork-type grab is capable of executing a forward/backward translation with respect to the lifting arm. Instead of moving the entire lifting arm forward/backward, only the fork-type grab is moved in this embodiment.

According to a third embodiment, the handling device comprises a first lifting pin and a second lifting pin, the first and the second lifting pin being fixed essentially perpendicular to a first and a second prong of the fork-type grab respectively. Thereby, the handling device is capable of picking up runner elements exclusively by rotation of the frame about the first axis of rotation and/or rotation of the handling member about the third axis of rotation. Therefore, it does not require a forward/backward movement of the fork-type grab, in conditions where this embodiment has sufficient flexibility.

Preferably, the handling device comprises a first hydraulic cylinder pivotably connected to the frame and to the lifting arm for lifting or lowering the second end portion of the lifting arm.

For large range of rotation of the frame, the handling device can comprise a first servo drive fixed to the frame and a first internally toothed gear rim fixed to the support base and centred on the first axis of rotation, the first servo drive comprising a gear wheel engaging the first gear rim for rotating the frame relative to the support base. In this case, the handling device, the first servo drive and the first gear rim can be arranged for rotation of the frame over a range of at least 200°.

In an advantageous conception of the second rotational joint, the handling device has a second servo drive fixed to the lifting arm and a second internally toothed gear rim fixed to the handling member and centred on the third axis of rotation, the second servo drive comprising a gear wheel engaging the second gear rim for pivoting the handling member with respect to the lifting arm. In this conception, the handling device, the second servo drive and the second gear rim can be arranged for pivoting the handling member over a range of about approximately 180°.

In the first embodiment, the handling device preferably comprises a second hydraulic cylinder pivotably connected to the frame and to the pivotable member for producing the forward/backward movement of the lifting arm by pivoting the pivotable member.

In the second embodiment, the handling device preferably comprises a second hydraulic cylinder connected to the fork-type grab and to the handling member for executing the forward/backward translation of the fork-type grab.

The handling device according to the present invention is adapted for use in a blast furnace installation with two proximate main runners extending radially from the blast furnace, for removing, parking, installing and/or exchanging both runner covers of both these two runners. Herein, the handling device being is installed between these two runners.

Accordingly, the present invention also concerns a blast furnace installation comprising a handling device according to the invention and at least two proximate tapping runners extending radially from the blast furnace. Herein the support base of the handling device is arranged on the cast house floor of the blast furnace installation essentially on the bisecting line of the angle between the longitudinal axes of the two tapping runners. In this installation, the operating range of the handling device is preferably greater than the distance between the first axis of rotation and the central axis of the tapping runners. Furthermore, the support base is preferably arranged on the cast house floor at a distance from the outer shell of the blast furnace which is greater than the operating range of the handling device.

### BRIEF DESCRIPTION OF THE DRAWINGS

The present invention and its advantages will be more apparent from the following description of not limiting embodiments with reference to the attached drawings. In these drawings, in which identical or similar parts are identified by identical reference numerals throughout,

FIG. 1: is a side view of a handling device according to a first embodiment;

FIG. 2: is a top view of the handling device in FIG. 1;

FIG. 3: is a longitudinal cross-sectional view according to III-III in FIG. 2, the handling device being in a forward configuration;

FIG. 4: is a longitudinal cross-sectional view according to IV-IV in FIG. 2, the handling device being in a configuration ready for transferring a runner cover;

FIG. 5: is a top view of a cast house floor in a blast furnace installation showing a handling device according to FIG. 1 in various postures;

FIG. 6: is a side view of a handling device according to a second embodiment;

FIG. 7: is a top view of a handling device according to a third embodiment.

### DETAILED DESCRIPTION OF THE INVENTION

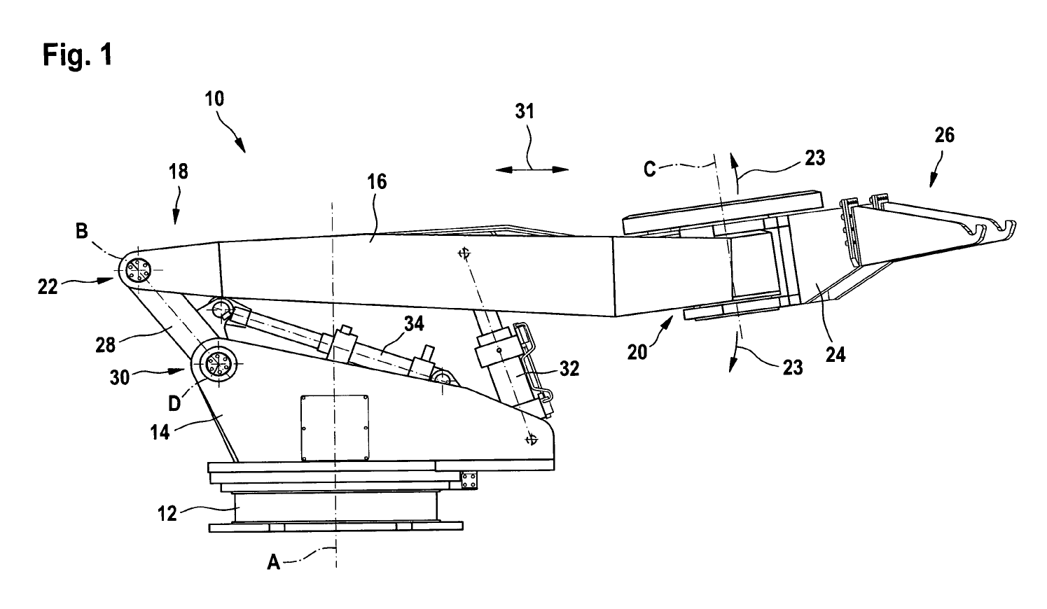

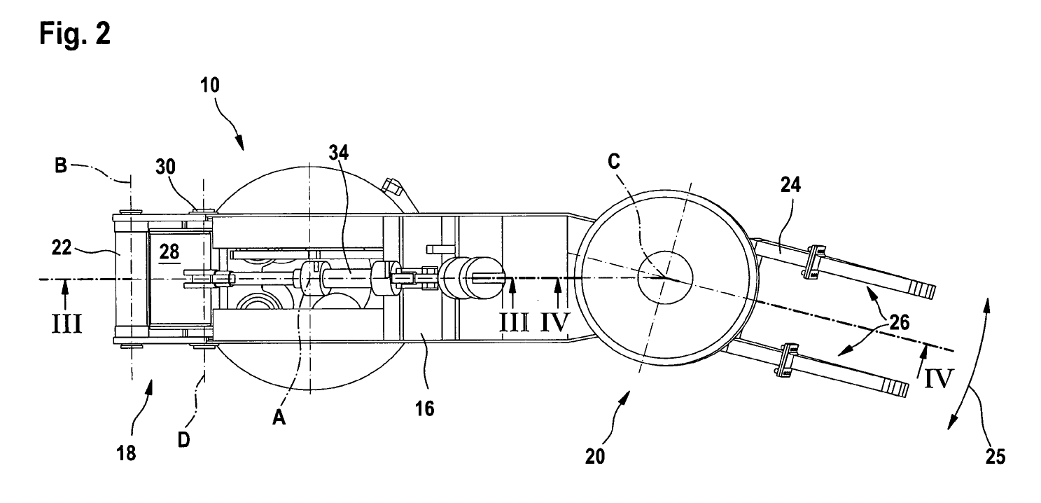

FIG. 1 and FIG. 2 show a handling device, generally identified by reference numeral 10. The handling device 10 comprises a support base 12 and a frame 14. The support base 12 is fixed on the cast house floor by suitable means and provides a stable stand for the handling device 10. The frame 14 is connected to the support base 12 by means of a bearing (detailed below) providing a first axis of rotation A, which is essentially vertical. Consequently, the frame 14 is supported by the support base 12 and rotatable relative thereto about axis A. It will be appreciated that the support base 12 and the frame 14 can be configured to allow rotation about essentially 360°. The range of rotation may however be limited according to constructional requirements, e.g. in order to prevent collision with fixed constructions. The handling device 10 further comprises a lifting arm 16 which has a first end portion 18 and an opposite second end portion 20. The first end portion 18 of the lifting arm 16 is connected to the frame 14 by means of a first rotational joint 22 providing a second axis of rotation B, which is essentially horizontal. The first rotational joint 22 itself is of conventional design known to the skilled person. Thus, the lifting arm 16 can pivot about axis B in a vertical plane in order to lower or lift its second end portion 20 according to arrows 23. The handling device 10 also comprises a handling member 24 which is connected to the second end portion 20 of the lifting arm 16 by means of a second rotational joint (detailed below) providing a third axis of rotation C, which lies in the geometrical plane that is perpendicular to axis B and passes through axis A. (In fact, axis C inclines in this plane with the lifting arm 16 pivoting about axis B.) Consequently, the handling member 24 is pivotable about axis C with respect to the lifting arm 16, according to arrows 25. In addition, the handling member 24 can be lifted or lowered according to arrows 23 as described above. A fork-type grab 26 is fixed to the handling member 24 for picking up and holding elements of tapping runners and more specifically runner covers.

As seen in FIG. 1 and FIG. 2, the frame 14 comprises a pivotable member 28, which is connected at its lower end portion to the frame 14, by means of a third rotational joint 30. The third rotational joint 30 is of known construction, similar to the rotational joint 22, and provides a fourth axis of rotation D, which is parallel to axis B, i.e. essentially horizontal. The lifting arm 16 is connected to the frame 14 at the upper end portion of the pivotable member 28. By pivoting the pivotable member 28 about axis D, the lifting arm 16 is moved forwards/backwards with respect to the frame 14 according to arrows 31.

As further seen in FIG. 1 and FIG. 2, the handling device 10 comprises a first hydraulic cylinder 32 for lifting or lowering the lifting arm 16. The first hydraulic cylinder 32 has the lower end of its housing pivotably connected to a front end portion of the frame 14 and the upper end of its piston pivotably connected to a central portion of the lifting arm 16. The working line of the first hydraulic cylinder 32 lies in a plane parallel or coplanar to the aforementioned plane of axis C (cf. III-III). The stroke end limits of the first hydraulic cylinder 32 predetermine the limits to the lifting and lowering motion following arrows 23. The handling device 10 further comprises a second hydraulic cylinder 34 forward/backward movement of the lifting arm 16. The second hydraulic cylinder 34 has the lower end of its housing pivotably connected to a front portion of the frame 14 and the upper end of its piston pivotably connected to a central portion of the pivotable member 28. The second hydraulic cylinder 34 moves the lifting arm 16 by pivoting the pivotable member 28. Again, limits to the movement according to arrows 31 are predetermined by the design of the second hydraulic cylinder 34. If required, the handling device 10, depending on the total stroke of hydraulic cylinders 32, 34, can be designed fully collapsible, i.e. into a posture where the lifting arm 16 rests on the upper edges of the frame 14. As will be noticed, the lifting arm 16 and the frame 14, together with the pivotable member 28 and the hydraulic cylinder 32, define a kinematic linkage in which the frame 14 forms the fixed link. This linkage defines motion for lifting or lowering according to arrows 23 and forward/backward movement according to arrows 31.

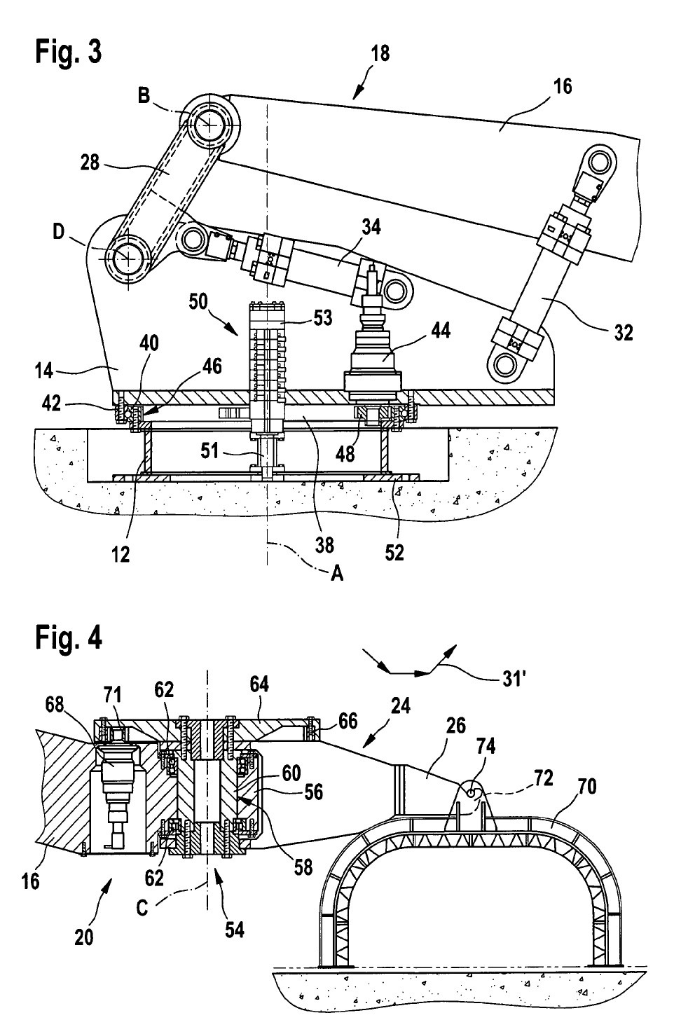

FIG. 3 shows the handling device 10 in a configuration, where the lifting arm 16 has been moved fully forward when compared to FIG. 1 and FIG. 3. This achieved by complete contraction of the hydraulic cylinder 34, which pivots the pivotable member 28 into the position shown in FIG. 3.

In FIG. 3, the bearing 38 which defines axis A can be seen in more detail. The bearing 38 is of rolling i.e. anti-frictional type and comprises an inner raceway ring 40 and an outer raceway ring 42 with steel balls there between. The inner raceway ring 40 is firmly attached to the support base 12 whereas the outer raceway ring 42 is firmly attached to the frame 14. Both raceway rings 40, 42 are arranged to be centred on and coaxial to axis A. This design allows the bearing 38 to support loads suspended to the fork-type grab 26, that may amount to 20'000 kg and more. FIG. 3 also shows a first servo drive 44 fixed to the frame 14 and a first gear rim 46 which is internally annular-toothed and fixed to the support base 12, e.g. by welding it inwardly to the inner raceway ring 40. The servo drive 44 and the gear rim 46 actuate the bearing 38. The gear rim 46 is centred on the first axis of rotation A. The servo drive 44 is mounted inside the front part of the frame 14 and drives a gear wheel 48 which engages the gear rim 46. Actuation of the servo drive 44 provides rotation of the frame 14, including lifting arm 16, handling member 24 and the fork-type grab 26, about axis A. This arrangement of the servo drive 44 and the bearing 38 allows rotating the frame 14 about 360° relative to the support base 12. It may be noted, that the handling device 10 preferably comprises a further servo drive mounted inside the frame 14, analogous to the servo drive 44, in order to allow load distribution and redundancy. As will be appreciated, mounting the first servo drive 44 inside the rotatable frame 14 and the gear rim 46 on the support base 12 instead of vice-versa, reduces the extent of structural modifications required at the cast house floor level an allows a compact construction of the handling device 10.

FIG. 3 further shows a power transmission coupling 50, for transferring hydraulic and electric power and control from the fixed support base 12 to the rotatable frame 14. The power transmission coupling 50 forms an interface for supply and control of the first and second hydraulic cylinders 32, 34 and the first servo drive 44 (and the second servo drive 68 detailed below). The power transmission coupling 50 comprises a fixed axle 51, mounted to a base plate 52 of the support base 12, and a bush 53 rotatable on the axle 51. It may be noted, that the axle 51 and the bush 53 are designed inter alia for sealingly transferring hydraulic oil from a fixed to a mobile machine part.

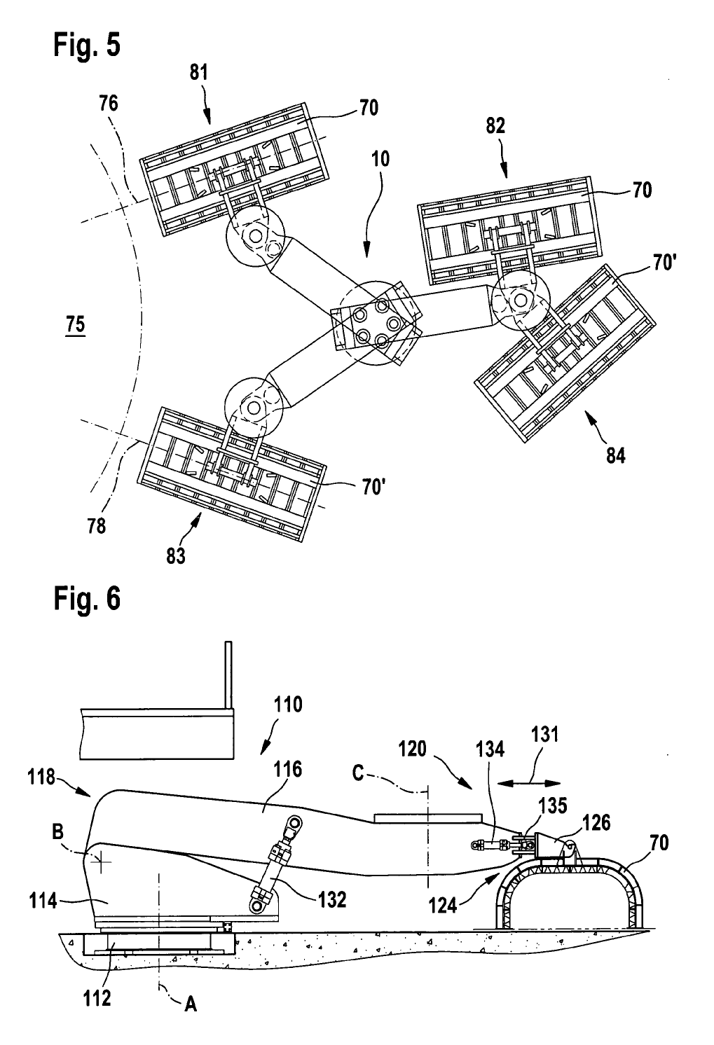

FIG. 4 shows in more detail the second rotational joint 54 which defines axis C. When seen from above, the second end portion 20 of the lifting arm 16 resembles a trailer draw bar, i.e. it tapers towards a rounded tip (see also FIG. 5). The tip of the second end portion 20 is arranged as a bearing head 56 for the second rotational joint 54. When seen form the side as in FIG. 4, the bearing head 56 has reduced height compared to the rest of the second end portion 20. The bearing head 56 is provided with a cylindrical through hole forming a bearing bush 58 for a shaft 60 having an integral upper head. A lower flange is fixed to the underside of the shaft 60 for securing it axially within the bearing bush 58. The second rotational joint 54 further comprises upper and lower roller bearings 62 located within adapted grooves in the bearing head 56.

As seen in FIG. 4, the handling member 24 is fixed in rotation to the shaft 60. On top, the handling member 24 comprises an inverted plate 64 also fixed to the shaft 60. To the protected underside of the inverted plate 64 is mounted a second internally toothed gear rim 66 which is centred on axis C. A second servo drive 68 is mounted in a cavity of bearing arm 16 such that a gear wheel 70 on is drive axle engages the second gear rim 66. This arrangement provides actuation of the second rotational joint 54, i.e. pivoting the handling member 24 with respect to the lifting arm 16. Due to the described shape of the second end portion 20 and the shape of the handling member 24, the handling member can pivot about axis C over a range of essentially 180°.

As seen in FIG. 4, the aforementioned linkage, comprising inter alia the lifting arm 16, is arranged such that the handling member 24, more precisely the central axis of the fork-type grab 26, has an essentially horizontal orientation in the configuration of FIG. 4. Consequently, movement according to arrow 31′, allows seizing a runner cover 70 (shown in cross-section in FIG. 4). In fact, such movement introduces both prongs 72 of the fork-type grab 26 underneath handling bars 74 provided on the runner cover 70 as seen in FIG. 4. Forward movement according to arrows 31′ includes lowering the fork-type grab 26 to some extent, due to the fixed radius of the pivotable member 28 and if required by means of the first hydraulic cylinder 32. Depending on the posture of the handling device 10 and/or the position and orientation of the runner cover 70, one or more adjustment steps of the handling member 24 (about axis C) and or the frame 14 (about axis A) may be required to introduce the prongs 72 properly underneath the handling bars 74. When the fork type grab 26 seizes the runner cover 70 as seen in FIG. 4, the latter can be picked up by extending the hydraulic cylinder 32. Subsequently, the runner cover 70 can be transferred to a different location, e.g. a parking position by appropriate actuation about axes A, B, C, D. Of course, reverse operation is possible accordingly.

FIG. 5 shows a plan view of different postures of the handling device 10 according to the first embodiment in a blast furnace installation. In FIG. 5, a blast furnace 75 and a first and a second runner 76, 78, which are proximate and extend radially from the blast furnace 75, are very schematically indicated. The blast furnace 75 may comprise e.g. two more runners and, associated thereto, an additional handling device on the opposite side (not shown). The first runner cover 70 is shown in an operating position 81 and in a garage position 82. A second runner cover 70′ is also shown in an operating position 83 and in a garage position 84. For each position 81, 82, 83, 84, a corresponding posture of the handling device 10 is shown in FIG. 5. Of course, the handling device 10 is capable of serving at various other positions within its working range, depending on the actual architecture of a blast furnace installation. Hence, the single handling device 10 is capable of bringing both the first runner cover 70 and the second runner cover 70′ from an operating position into a garage position and vice versa.

As further seen in FIG. 5, the handling device 10 is arranged on the cast house floor laterally of the tapping runners 76, 78 and preferably on the bisecting line between (the central axes of) the two tapping runners 76, 78. Furthermore, the operating range of the handling device 10 is greater than the distance between the axis of rotation A and the central axes of the tapping runners 76, 78. Furthermore, the support base 12 of the handling device 10 is installed at a distance from the outer shell of the blast furnace 75 greater than the operating range of the handling device 10. Thereby inter alia collisions, e.g. with the furnace shell among others, are intrinsically avoided. As seen, in FIG. 5 (in particular position 82) the handling member 24 can be pivoted into a limit position where it is at a right angle i.e. 90° with the lifting arm 16. As will be appreciated, the described configuration enables pivoting of the handling member 24 over a range of 180° even whit the runner cover 70, 70′ attached thereto. Preferably the lifting stroke provided by the hydraulic cylinder 32 provides a lifting height at the fork-type grab 26 which exceeds the total height of a runner cover. This measure allows to exchange runner covers 70, 70′ if required, e.g. by placing the runner cover 70 directly from position 81 into position 83.

FIG. 6 shows a handling device 110 according to a second embodiment of the invention. For conciseness, only the differences of the second embodiment with respect to the first embodiment are detailed below. In fact, the handling device 110 seen in FIG. 6 is in most aspects similar to the handling device 10. It namely also comprises a support base 112, a frame 114, a lifting arm 116 having a first and second end portion 118, 120 and a handling member 124 provided with a fork type grab 126. The handling device 120 comprises a bearing and rotational joints for rotation or pivoting about axes A, B, C respectively. Alike the first embodiment, the handling device 110 also comprises a first hydraulic cylinder 132 for lifting/lowering the lifting arm 116, by pivoting about axis C. The major difference in the handling device 110 resides in the fact, that the frame 114 is not provided with a pivoting member, instead, the first end portion 118 of the lifting arm lifting arm 116 is directly connected to the rigid body of the frame 114 at axis B. However, the handling device 110 is arranged for translation of the fork type grab 126 according to arrows 131, as seen in FIG. 6. The second end portion 120 comprises a second hydraulic cylinder 134 arranged forward/backward stroke in a plane perpendicular to axis C and in the direction of prolongation of the handling member 124. As further seen in FIG. 6, the fork-type grab 126 and the handling member 124 are arranged such that the former is extractable with respect to the latter by means of a rectilinear sliding joint 135. The second hydraulic cylinder 134 provides actuation of the sliding joint 135, i.e. commands forward/backward translation of the fork-type grab 126 according to arrows 131, with respect to the handling member 124 and the lifting arm 116. As will be appreciated, the handling device 110 according to the variant shown in FIG. 6 has similar properties and offers essentially the same advantages as the previously described embodiment.

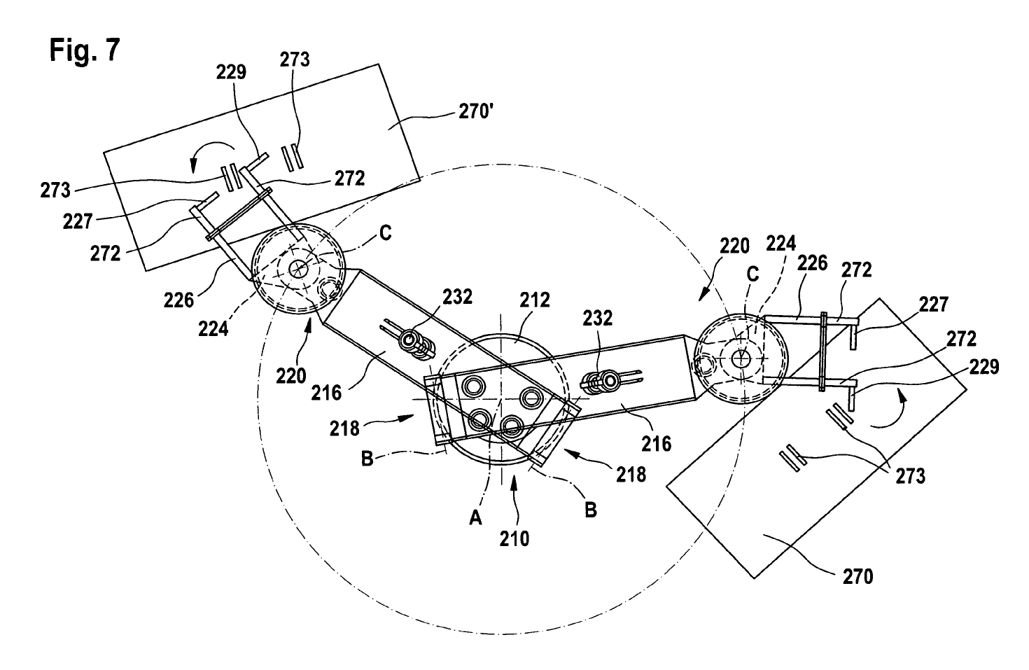

FIG. 7 shows a handling device 210 according to a third embodiment of the invention. Only the differences with respect to the previous embodiments are detailed below. Similar or identical parts are referenced in FIG. 7 with reference numerals having identical units and tens digits but a hundreds digit increased by one. Whereas the previously described embodiments each possess one forward/backward (translational) degree of freedom (DOF) and three rotational DOF, the handling device 210 is designed with three rotational DOF about axes A, B, C only. Hence, the handling device 210 is devoid of any translational DOF. The fork type grab 226 of the handling device 210 is provided with a first and a second lifting pin 227 and 229, fixed essentially perpendicular to the prongs 272. Instead of handling bars, the runner covers 270, 270′ adapted for the handling device 210 comprise eyelet flanges 273 having eyelets matching the lifting pins 227 and 229 of the handling device 210. Due to this arrangement, the handling device 210 can pick up, transfer and put down runner covers 270, 270′ without forward/backward DOF. Consequently, the handling device 210 has reduced complexity and requires only one hydraulic cylinder 232, while offering a flexibility in positioning comparable to the previous embodiments. It may be noted, that the frame 214 of the handling device 210, alike the frame 114, is devoid of pivotable member.

A first important aspect to be noted is the suitability of the handling device 10, 110, 210 for service at two different neighbouring casting runners of a blast furnace. It will also be appreciated that the described configuration of the handling devices 10, 110, 210 allows the latter to be used in many different cast house architectures inter alia due to a wide variety of working and parking positions accessible by the handling device. Due to its flexibility of posture and its construction, the handling device 10, 110, 210 be installed without requiring excessive, if any, changes to existing installations. Many prior art handling devices have a configuration like a cantilever crane, with a horizontal boom that is supported by and can rotate about a vertical pillar. In order to insure the handling device cannot overturn, the pillars of prior art devices are often fixed at their upper end to some rigid structure present in the cast house. Since the handling device 10, 110, 210 according to the present invention is of a floor-mounted type, it can readily be installed at many different locations in a cast house, irrespective of the architecture of the latter. Since the handling device 10, 110, 210 can be placed at a certain distance from the blast furnace and the casting runners, it constitutes no obstruction for tapping, plugging and other appliances required near the taphole or the casting runner. Furthermore, the handling device 10, 110, 210 is adapted to avoiding obstacles such as gas emission evacuation hoods and conducts, even when carrying a bulky runner cover.

Another important aspect to be noted is the suitability of the handling device 10, 110, 210 for process automation, e.g. fully automated removal and installing of two runner covers (70, 70′) before and after tapping or plugging the taphole on a blast furnace. In fact, in the minimal embodiment, the handling device 210 represents a specially developed sort of robot arm, similar to a polar robot arm (about axis A, B) devoid of a wrist rotation DOF and provided with an end effector having a single DOF (about axis C). The first two preferred embodiments 10, 110 add one DOF, i.e. forward/backward movement or translation (arrows 31, 131), to the end effector (i.e. handling member 24). Accordingly, the handling device 10, 110, 210 is perfectly suitable for automated operation implementing techniques known to the skilled person. It is however not excluded to equip the handling device 10, 110, 210 for manual control.

Finally, while the handling device 10, 110, 210 has been described in the context of transferring a runner cover of the upstream tapping runner, i.e. the blast furnace main runner, it is not excluded that the device can be used for transferring other runner elements, e.g. a downstream main runner cover or accessories of the pig iron or slag runners. Furthermore, angular definitions given for the preferred embodiments, may be departed from in other embodiments according to the invention. Hence, where terms such as vertical, horizontal, perpendicular, parallel, etc. are used for describing preferred embodiments, those skilled in the art will understand that, depending on local conditions, deviations of several angular degrees (°) or even up to 30° from such angular definitions may be possible or even required, without departing from the concept of a handling device according to the invention.

1.-15. (canceled)

16. A handling device for elements of tapping runners on a shaft furnace, in particular for runner covers, comprising:
a support base arranged laterally of said tapping runner;
a frame which is supported by said support base;
a bearing connecting said frame to said support base, said bearing defining a first axis of rotation, which is essentially vertical, about which said frame can rotate relative to said support base;
a lifting arm having a first end portion and a second end portion;
at least a first rotational joint connecting said first end portion to said frame, said first rotational joint defining a second axis of rotation, which is essentially horizontal, about which said lifting arm can pivot in order to lower or lift its second end portion;
a handling member connected to said second end portion of said lifting arm;
a second rotational joint connecting said handling member to said second end portion, said second rotational joint defining a third axis of rotation, which lies in a plane essentially perpendicular to said second axis of rotation and about which said handling member can pivot with respect to said lifting arm; and
a fork-type grab connected to said handling member and arranged so as to allow picking up; transferring and putting down elements of tapping runners.

17. The handling device according to claim 16, further comprising:
a third rotational joint;
said frame comprising a pivotable member;
said third rotational joint connecting said pivotable member to said frame and said third rotational joint defining a fourth axis of rotation, which is parallel to said second axis of rotation,
wherein said lifting arm is connected to said pivotable member, such that said lifting arm is capable of executing a forward/backward movement with respect to said frame.

18. The handling device according to claim 16, further comprising:
a rectilinear sliding joint connecting said fork-type grab to said handling member such that said fork-type grab is capable of executing a forward/backward translation with respect to said lifting arm.

19. The handling device according to claim 16, further comprising:
a first lifting pin and a second lifting pin;
said fork-type grab comprising a first and a second prong;
said first and said second lifting pin being fixed essentially perpendicular to said first and said second prong of said fork-type grab respectively such that said handling device is capable of picking up elements of tapping runners by rotation of said frame about said first axis of rotation and/or rotation of said handling member about said third axis of rotation.

20. The handling device according to claim 16, further comprising:
a first hydraulic cylinder pivotably connected to said frame and to said lifting arm for lifting or lowering said second end portion of said lifting arm.

21. The handling device according to claim 16, further comprising:
a first servo drive fixed to said frame;
a first internally toothed gear rim fixed to said support base and centred on said first axis of rotation;
said first servo drive comprising a gear wheel engaging said first gear rim for rotating said frame relative to said support base.

22. The handling device according to claim 21, wherein said handling device, said first servo drive and said first gear rim are arranged for rotation of said frame over a range of at least 200°.

23. The handling device according to claim 16, comprising:
a second servo drive fixed to said lifting arm;
a second internally toothed gear rim fixed to said handling member and centred on said third axis of rotation;
said second servo drive comprising a gear wheel engaging said second gear rim for pivoting said handling member with respect to said lifting arm.

24. The handling device according to claim 23, wherein
said handling device, said second servo drive and said second gear rim are arranged for pivoting said handling member over a range of about approximately 180°.

25. A handling device for handling elements of tapping runners of a shaft furnace installation, in particular for handling runner covers, said device comprising:
a support base;
a frame which is supported by said support base;
a bearing connecting said frame to said support base, said bearing having a first axis of rotation, which is essentially vertical, about which said frame can rotate relative to said support base;
a lifting arm having a first end portion and a second end portion;
at least a first rotational joint connecting said first end portion to said frame, said first rotational joint having a second axis of rotation, which is essentially horizontal, about which said lifting arm can pivot in order to lower or lift its second end portion;
a handling member connected to said second end portion of said lifting arm;
a second rotational joint connecting said handling member to said second end portion, said second rotational joint having a third axis of rotation, which lies in a plane essentially perpendicular to said second axis of rotation and about which said handling member can pivot with respect to said lifting arm;
a fork-type grab connected to said handling member;
a first servo drive fixed to said frame;
a first internally toothed gear rim fixed to said support base and centred on said first axis of rotation;
said first servo drive comprising a gear wheel engaging said first gear rim for rotating said frame relative to said support base.

26. The handling device according to claim 25, wherein
said handling device, said first servo drive and said first gear rim are arranged for rotation of said frame over a range of at least 200°.

27. The handling device according to claim 26, further comprising:
a second servo drive fixed to said lifting arm;
a second internally toothed gear rim fixed to said handling member and centred on said third axis of rotation;
said second servo drive comprising a gear wheel engaging said second gear rim for pivoting said handling member with respect to said lifting arm.

28. The handling device according to claim 27, wherein
said handling device, said second servo drive and said second gear rim are arranged for pivoting said handling member over a range of about approximately 180°.

29. The handling device according to claim 28, further comprising:
a third rotational joint;
said frame comprising a pivotable member;
said third rotational joint connecting said pivotable member to said frame and said third rotational joint defining a fourth axis of rotation, which is parallel to said second axis of rotation,
wherein said lifting arm is connected to said pivotable member, such that said lifting arm is capable of executing a forward/backward movement with respect to said frame.

30. The handling device according to claim 28, further comprising:
a rectilinear sliding joint connecting said fork-type grab to said handling member such that said fork-type grab is capable of executing a forward/backward translation with respect to said lifting arm.

31. The handling device according to claim 28, further comprising:
a first lifting pin and a second lifting pin;
said fork-type grab comprising a first and a second prong;
said first and said second lifting pin being fixed essentially perpendicular to said first and said second prong of said fork-type grab respectively such that said handling device is capable of picking up elements of tapping runners by rotation of said frame about said first axis of rotation and/or rotation of said handling member about said third axis of rotation.

32. The handling device according to claim 29, further comprising
a second hydraulic cylinder pivotably connected to said frame and to said pivotable member for producing said forward/backward movement of said lifting arm by pivoting said pivotable member.

33. The handling device according to claim 30, further comprising
a second hydraulic cylinder connected to said fork-type grab and to said handling member for executing said forward/backward translation of said fork-type grab.

34. The handling device according to claim 17, further comprising
a second hydraulic cylinder pivotably connected to said frame and to said pivotable member for producing said forward/backward movement of said lifting arm by pivoting said pivotable member.

35. The handling device according to claim 18, further comprising
a second hydraulic cylinder connected to said fork-type grab and to said handling member for executing said forward/backward translation of said fork-type grab.

36. A blast furnace installation with a blast furnace and a cast house floor, said installation including:
a handling device for handling elements of tapping runners in said installation, in particular for handling runner covers, said device comprising:
a support base arranged laterally of said tapping runner;
a frame which is supported by said support base;
a bearing connecting said frame to said support base, said bearing defining a first axis of rotation, which is essentially vertical, about which said frame can rotate relative to said support base;
a lifting arm having a first end portion and a second end portion;
at least a first rotational joint connecting said first end portion to said frame, said first rotational joint defining a second axis of rotation, which is essentially horizontal, about which said lifting arm can pivot in order to lower or lift its second end portion;
a handling member connected to said second end portion of said lifting arm;
a second rotational joint connecting said handling member to said second end portion, said second rotational joint defining a third axis of rotation, which lies in a plane essentially perpendicular to said second axis of rotation and about which said handling member can pivot with respect to said lifting arm; and
a fork-type grab connected to said handling member and arranged so as to allow picking up; transferring and putting down elements of tapping runners;
at least two proximate tapping runners extending radially from said blast furnace;
wherein said support base of said handling device is arranged on said cast house floor between said two tapping runners.

37. The installation according to claim 36, wherein said support base of said handling device is arranged on said cast house floor essentially on the bisecting line between said two tapping runners.

38. The installation according to claim 36, wherein said handling device has an operating range greater than the distance between said first axis of rotation and the central axis of said tapping runners.

39. The installation according to claim 38, wherein said blast furnace comprises an outer shell and said support base is arranged on the cast house floor at a distance from said outer shell which is greater than said operating range.

40. The installation according to claim 36, wherein said proximate runners are main blast furnace runners and said handling device allows removing, parking, installing and/or exchanging both runner covers of both said blast furnace main runners respectively.
